(19) United States
(12) Patent Application Publication
(10) Pub. No.: US 2015/0189204 A1
(43) Pub. Date: Jul. 2, 2015

(54) Semiconductor Device On Cover Substrate And Method Of Making Same

(71) Applicant: Optiz, Inc., Palo Alto, CA (US)

(72) Inventors: Vage Oganesian, Sunnyvale, CA (US); Zhenhua Lu, East Palo Alto, CA (US)

(73) Assignee: Optiz, Inc.

(21) Appl. No.: 14/562,349

(22) Filed: Dec. 5, 2014

Related U.S. Application Data
(60) Provisional application No. 61/921,323, filed on Dec. 27, 2013.

(51) Int. Cl. H04N 5/369; G06K 9/00

(52) U.S. Cl. CPC H04N 5/369; G06K 9/00087; G06K 9/00013

(57) ABSTRACT

A sensor device comprising a sensor die, a second substrate and a conductor assembly. The sensor die includes a first substrate having front and back surfaces, a sensor disposed in or at the front surface, bond pads disposed in or at the front surface and electrically coupled to the sensor, and a plurality of openings each extending from the back surface to one of the bond pads. The second substrate has top and bottom surfaces, wherein the bottom surface of the second substrate is mounted to the front surface of the first substrate. The conductor assembly is electrically coupled to at least some of the bond pads through at least some of the openings.

### RELATED APPLICATIONS

This application claims the benefit of U.S. Provisional Application No. 61/921,323, filed Dec. 27, 2013, and which is incorporated herein by reference.

### FIELD OF THE INVENTION

The present invention relates to biometrics identification sensors, and more particularly to the packaging of such devices.

### BACKGROUND OF THE INVENTION

Electronic devices and particularly mobile electronic devices are becoming more prevalent. The data being handled in these devices are growing in both quantity and sensitivity. Security devices are needed to protect users of electronic devices from potential harm. Such security devices need to excel in accuracy, form factor and usability.

A conventional fingerprint sensor device is disclosed in U.S. Pat. No. 8,358,816, which is incorporated herein by reference. The disclosed device uses a linear light sensor to capture the user's fingerprint. However, the linear light sensor can be easily hacked, thus making it a very weak security device. For example, one could simply print out a fingerprint on a sheet of paper and use the printed finger print to gain access to the device protected by the fingerprint sensor device. The linear light sensor cannot distinguish between the fake paper copy and the real finger. Additionally, the linear light sensor also requires the user to make a swiping motion. The swipe has to be precise and well positioned, thus making it sometimes difficult to use. Finally, the package for this device is not designed with form factor and device integration in mind. The packaging is bulky, and generally needs a specially designed device cover with a window.

There is a need for an improved biometric identification sensor.

### BRIEF SUMMARY OF THE INVENTION

The aforementioned problems and needs are addressed by a sensor device comprising a sensor die, a second substrate and a conductor assembly. The sensor die includes a first substrate having front and back surfaces, a sensor disposed in or at the front surface, bond pads disposed in or at the front surface and electrically coupled to the sensor, and a plurality of openings each extending from the back surface to one of the bond pads. The second substrate has top and bottom surfaces, wherein the bottom surface of the second substrate is mounted to the front surface of the first substrate. The conductor assembly is electrically coupled to at least some of the bond pads through at least some of the openings.

A method of forming a sensor device comprises providing a sensor die (which includes a first substrate having front and back surfaces, a sensor disposed in or at the front surface, and bond pads disposed in or at the front surface and electrically coupled to the sensor), forming a plurality of openings each extending from the back surface to one of the bond pads, mounting a bottom surface of a second substrate to the front surface of the first substrate, and electrically coupling a conductor assembly to at least some of the bond pads through at least some of the openings.

Other objects and features of the present invention will become apparent by a review of the specification, claims and appended figures.

### BRIEF DESCRIPTION OF THE DRAWINGS

FIGS. 1-4, 5A-5C, 6A-6D and 7-8 are side cross sectional views illustrating the formation of the packaged sensor of the present invention.

FIG. 5D are top views illustrating the pattern of slot(s) for forming the ground plane.

FIGS. 9-13 are side cross sectional views illustrating alternate embodiments for interconnecting the various components.

### DETAILED DESCRIPTION OF THE INVENTION

The present invention is a biometrics identification (fingerprint) sensor, packaging of fingerprint sensor, and integration of such device. The sensor achieves optimal reading of fingerprints using sensory techniques such as capacitive, electromagnetic, infrared and photonic. The present invention includes packaging and integrating of such device into an electronic system, where the sensor can be disposed directly under the screen (or as part of a screen) of a handset device for user's fingerprint recognition and authentication.

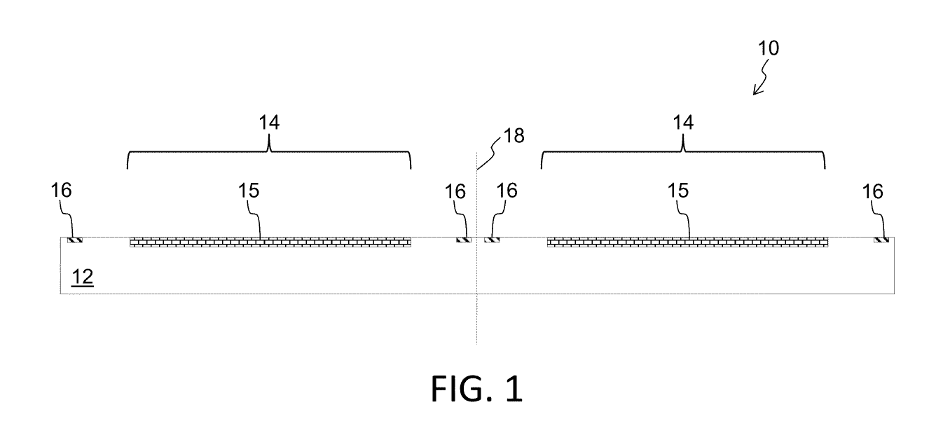

FIGS. 1-8 illustrate the steps in forming the packaged sensor, which begin by providing a sensor wafer 10 that includes a silicon substrate 12, sensor active areas 14 each containing one or more sensors 15, and bond pads 16 electrically coupled to the sensors 15, as shown in FIG. 1. Each active area 14 can include one or more of the following sensors: capacitive sensor, electromagnetic sensor, IR sensor and/or photonic sensor. The sensor active area 14 can be composed of multiple types of sensors that are placed side by side, over the top of another, or interlaced. The sensor(s) in active area 14 generate output signal(s) in response to external stimuli at or near the substrate surface, which are coupled to the bond pads 16. Multiple active areas 14 are formed on a single sensor wafer 10, and later separated along scribe lines 18 therebetween to form individual sensor die. The formation and configuration of such sensor wafers are well known and not further described herein. Optional silicon thinning can be performed on the back surface of substrate 12 (opposite the front surface of substrate 12 at which the sensors 15 and bond pads 16 are located) by mechanical grinding, chemical mechanical polishing (CMP), wet etching, atmospheric downstream plasma (ADP), dry chemical etching (DCE), and/or a combination of aforementioned processes or any another appropriate silicon thinning method(s) to reduce the thickness of substrate 12.

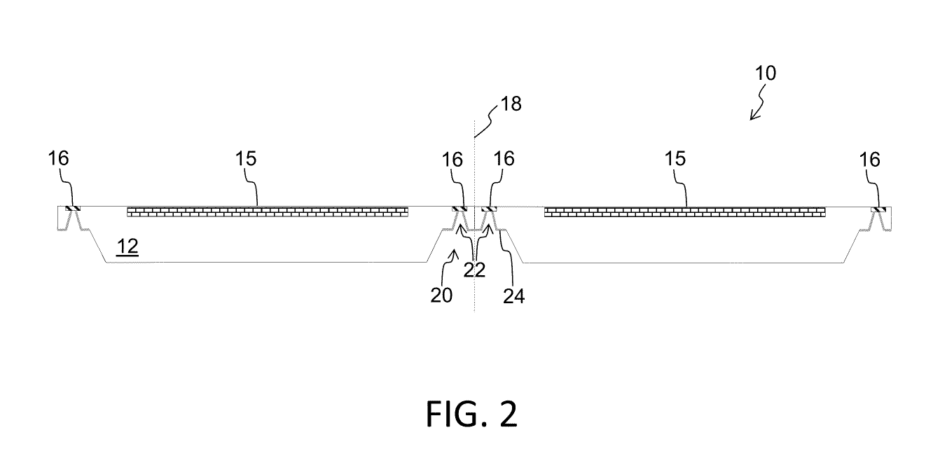

Trenches 20 are formed into the back surface of substrate 12 along the scribe lines 18 and over the sensor bond pads 16). Trenches 20 can be formed using a photolithographic mask and anisotropic dry etch process, which is well known in the art. Trenches 20 preferably extend toward but do not reach the front surface of substrate 12. Mechanical sawing or any other mechanical milling process can instead be used to form the trenches 20. Vias (i.e. holes) 22 are formed into the silicon from the bottoms of trenches 20 to expose sensor bond pads 16. Holes 22 can be formed by laser, dry etch, wet etch or any another appropriate VIA forming methods that are well known in the art. Each trench 20 and corresponding hole 22 form an opening extending from the back surface of the substrate to one of the bond pads 16. An optional passivation material 24 can be deposited on the walls of holes 22, and in trenches 20 around the openings of holes 22, while leaving the sensor bond pads 16 exposed at the ends of holes 22. While not shown, the entire backside of the silicon wafer 10 can be coated with passivation material 24 as well. Passivation material 24 can be silicon dioxide or silicon nitride. Preferably, the passivation layer 24 is made of at least 0.5 μm of silicon dioxide, formed using a silicon dioxide deposition method which can be Physical Vapor Deposition (PVD) or any another appropriate deposition method(s). The resulting structure is shown in FIG. 2.

The VIA holes 22 can further be optionally coated or filled with conductive material such as copper or any other conductive material that are well known in the art. A metallic material such as copper is preferred, and can be deposited by a plating or sputtering process. The copper is then selectively removed using lithographic etching process, leaving the vias coated or filled with copper. Optionally, traces and routes can be formed in the trenches 20 and on the back surface of the substrate 12. At this time, an enhancement layer can optionally be formed on the front surface of substrate 12. The enhancement layer can be an anti-reflective coating, an electromagnetic shielding layer, an antenna layer, an optical filter layer, a microlens layer, and/or any other sensor enhancement layer(s) that are commonly used in the art to enhance sensor devices.

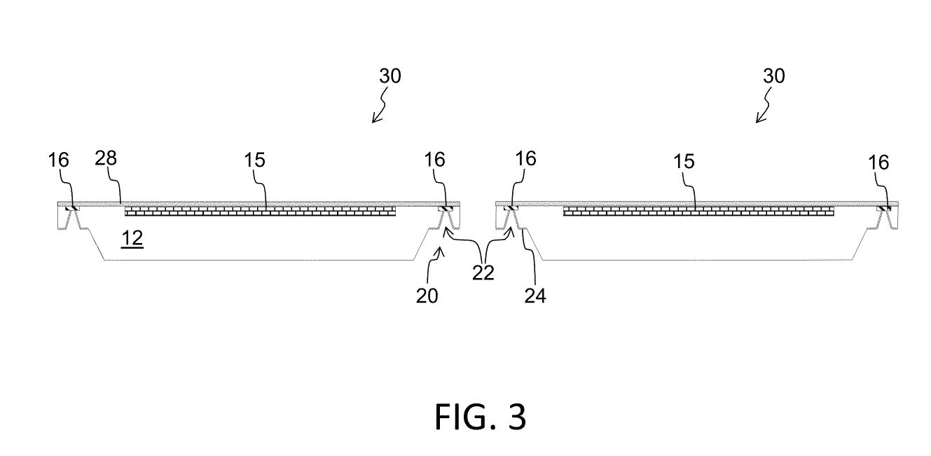

An adhesive layer 28 is preferably formed over the front surface of substrate 12, which can be reaction-setting adhesive, die attach tape, thermal-setting adhesive or a wafer bonding agent of any other type that is well known in the art. The adhesive layer is preferably 0.1 tm to 100 μm in thickness. Alternatively, the adhesive layer 28 can instead be deposited on the cover substrate described below, or on both the cover substrate and the substrate 12. The adhesive agent is not activated at the current state. The adhesive layer 28 can be planarized and thinned through chemical or mechanical processes that are well known in the art. It should be noted that the adhesive layer 28 can be omitted altogether, whereby the sensor chip can be held onto the cover substrate by molding material. Wafer level dicing/singulation of components along the scribe lines 18 can be done with mechanical blade dicing equipment, laser cutting, chemical etching or any other appropriate processes to result in individual semiconductor devices (e.g. individual sensor devices) each on a separate sensor die 30, as shown in FIG. 3.

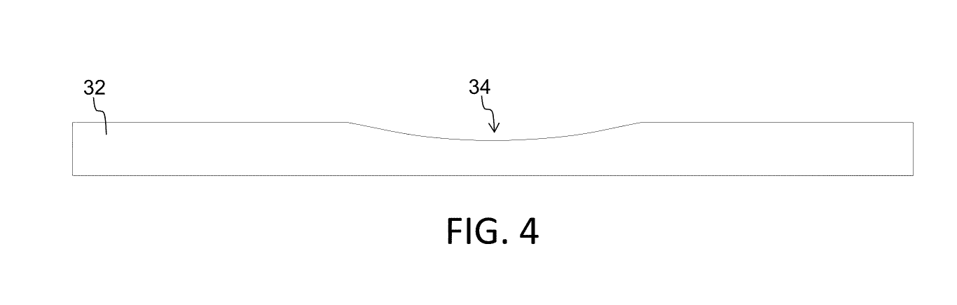

A cover substrate 32 is provided which can be, for example, glass with layers of coatings and other electronic device structures that can be included on a device cover. Cover substrate 32 is preferably made of a dielectric material such as plastic, glass, etc. Optical transparency of the cover substrate 32 is preferred or even required if the sensor 15 includes a photonic sensor. Otherwise, the cover substrate 32 is preferably made of optically opaque material such as glass. The cover substrate 32 could be configured for positioning directly under the screen of a portable device, positioned in an aperture of such a screen, or could even be a portion of such a screen. A recess 34 can optionally be formed in the top surface of the cover substrate 32 which will be positioned over the sensor 15 to enhance sensor's sensitivity. The sensitivity is increased due to the reduction in distance between the external environment and the sensor 15. The recess 34 can be formed by etching, mechanical milling or any other appropriate methods for the particular cover substrate. The depth of recess 34 is preferably greater than 30% of the cover substrate's overall thickness. The resulting structure is shown in FIG. 4.

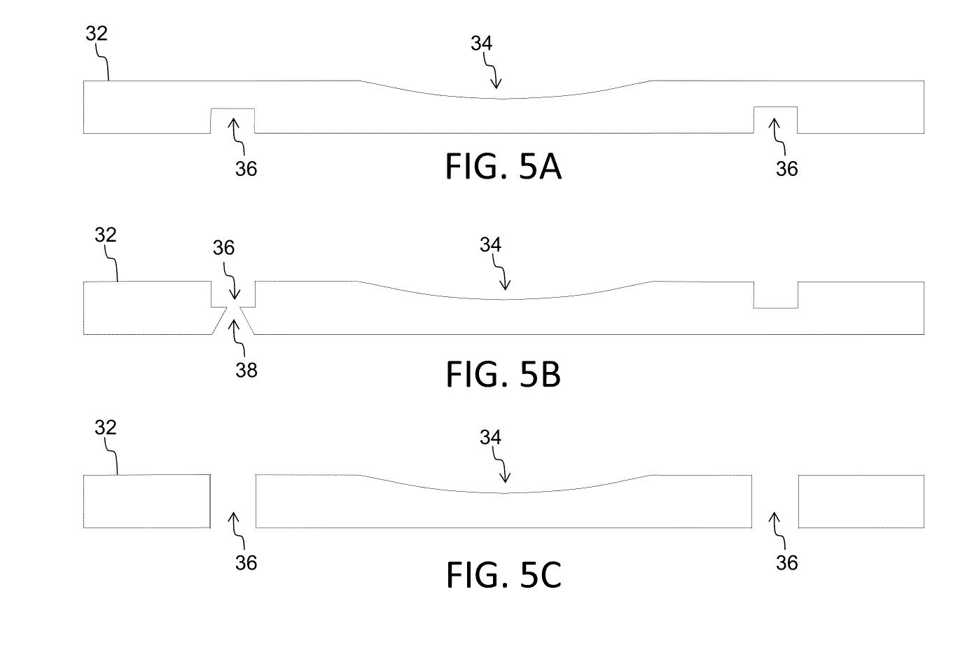

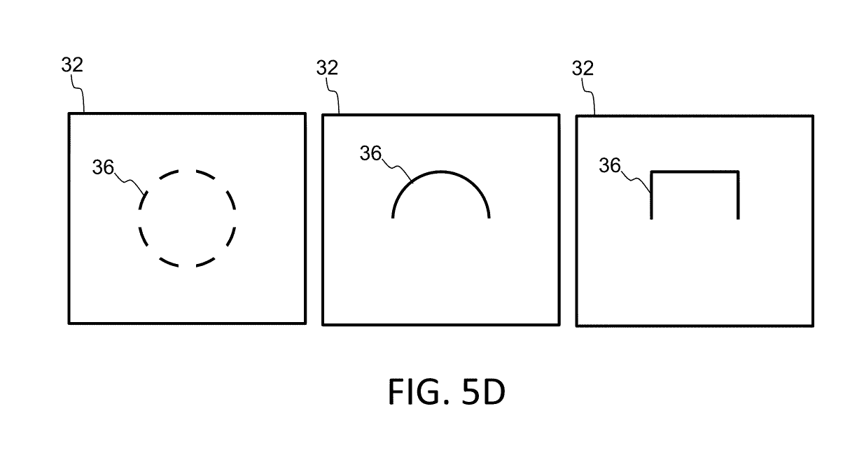

A ground plane slot 36 can be formed in the top or bottom surfaces of the cover substrate 32. Slot 36 can be formed by etching, laser, mechanical milling or any other appropriate methods. The pattern of the slot 36 can be random (or pseudo random) and over any desired locations on the cover substrate 32. The walls of the slot 36 can be tapered or vertical. For example, the slot 36 can be a slot having vertical sidewalls formed into the bottom surface of substrate 32 as shown in FIG. 5A. Alternately, the slot 36 can be formed into the top surface of the cover substrate, followed by the formation of a corresponding via hole 38 in the bottom surface that reaches slot 36, as illustrated in FIG. 5B. Or, the slot can extend all the way through the cover substrate 32 (from the top to the bottom surfaces) as illustrated in FIG. 5C. In the latter case, the slot 36 should not create a continuous window in the cover substrate 32 that would jeopardize the integrity of the substrate (i.e. should be in the form of discontinuous patterns as shown in FIG. 5D).

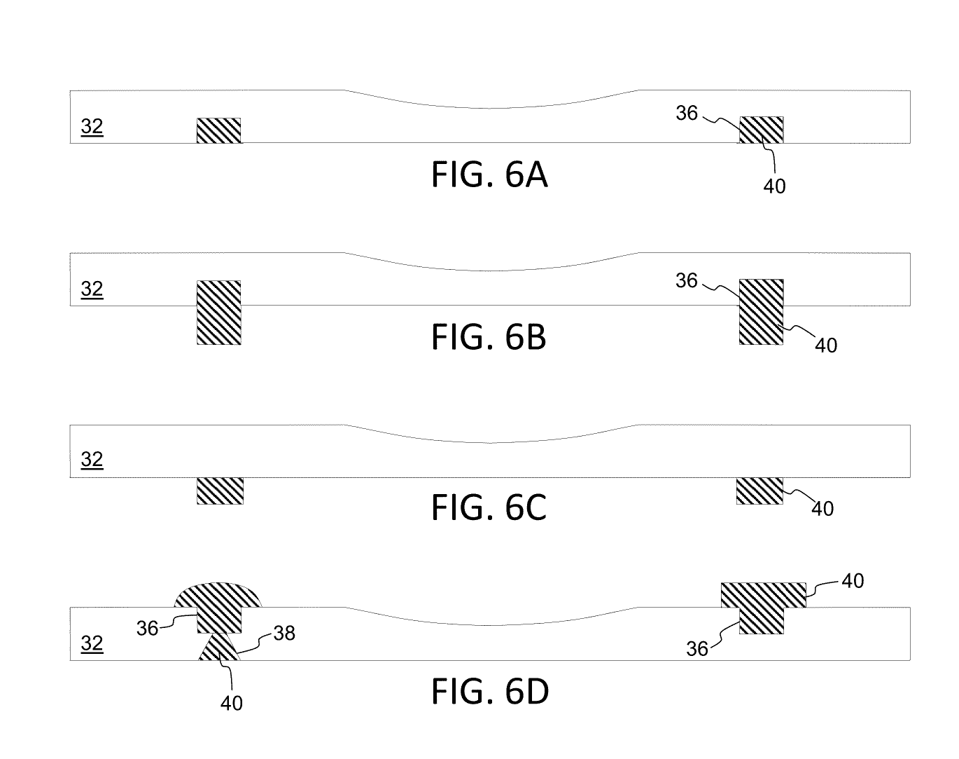

A ground plane 40 is formed by filling slot 36 with conductive material, preferably metallic material. The ground plane 40 acts as a ground plane antenna for a capacitive type sensor. Metallic material such as aluminum, copper, steel, gold, silver or any other metalloid can be used. The metal can be deposited by sputtering, plating or pre casted block which can be inserted into the ground plane slot 36. This metallic structure offers many properties such as electromagnetic shielding, cosmetic enhancement, usability improvement, but in general, the structure is used by the capacitive sensor where it has a focus plane and ground plane. In order to increase the focus plane sensitivity and accuracy, the ground plane is made larger. The bigger the ground plane in comparison to the focus plane the less sensitive it is, and the more accurate the focus plane will be. The ground plane is optional, and can exist elsewhere in the electronic device. FIG. 6A illustrates the ground plane 40 formed by conductive material disposed in slots 36 formed in the bottom surface of the substrate 32. FIG. 6B illustrates the same ground plane 40, but where the conductive material extends out of slots 36. FIG. 6C illustrates ground plane 40 formed by conductive material disposed on the bottom surface of substrate 32, where no slots are formed or used.

FIG. 6D illustrates ground plane 40 formed as conductive material formed in slot 36 in the substrate's top surface and extending out of slot 36, as well as conductive material formed in slot 36 and via holes 38 with a rounded portion extending out of slot 36.

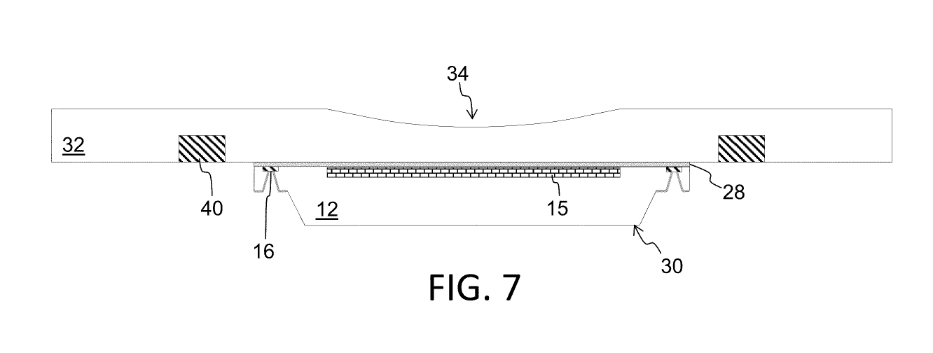

The sensor die 30 is then mounted to the cover substrate 32, preferably using the previously discussed thin layer of adhesive 28. Alternately, the thin layer of adhesive 32 is deposited on the bottom surface cover substrate 32, where the adhesive is not activated at the current state. The adhesive layer is preferably planarized, and has a thickness of 0.1 μm to 100 μm. The sensor die 30 can then be picked and placed on the cover substrate 32 (i.e. the front surface of substrate 12 mounted to the bottom surface of cover substrate 32). The adhesive layer can be activated by heat, pressure, chemical agent or any other appropriate methods. The sensor die 30 can be placed anywhere on the bottom surface of the cover substrate 32, but preferably is aligned to the recess 34 if one exists. The resulting structure is shown in FIG. 7.

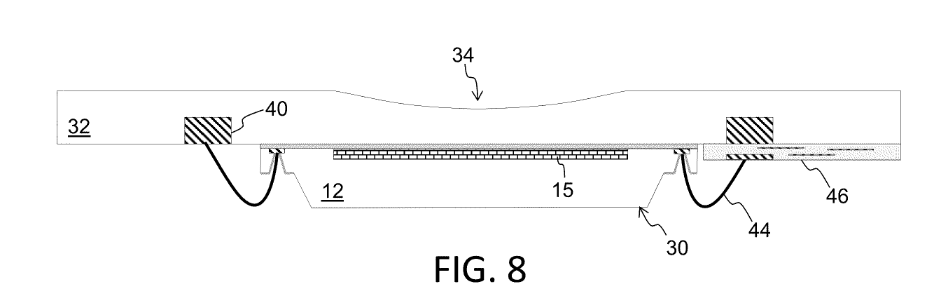

The sensor die 30 can be electrically connected to external circuitry by wirebonds 44 and/or a conductor assembly 46. Wirebonding is well known in the art, and the conductor assembly 46 can be for example, a flexible printed circuit board (flexible PCB), rigid PCB, etc., preferably mounted to cover substrate 32. If the sensor die 30 contains capacitive circuits, then preferably sensor die 30 is also connected to the ground plane 40 or some sort of large metallic structure or metallic network. The resulting structure is shown in FIG. 8.

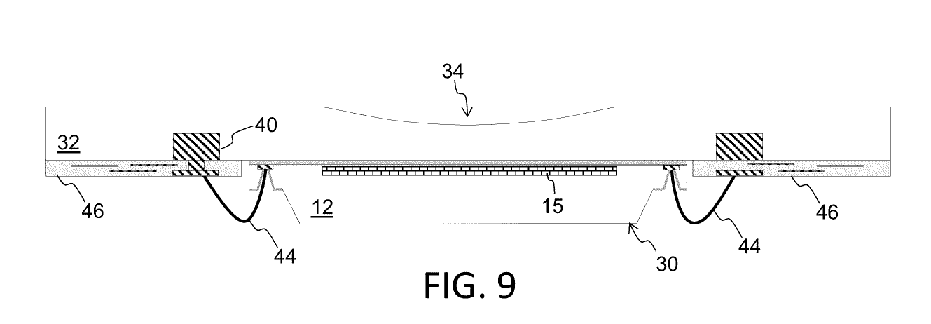

FIG. 9 illustrates an alternate interconnection embodiment, where the connection from the sensor die 30 to the ground plane 40 is routed through the conductor assembly 46, which is also connected to the sensor bond pads 16 by wirebond 44.

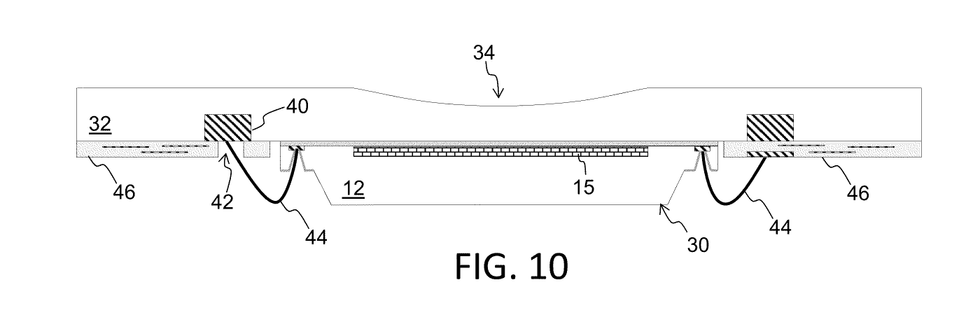

FIG. 10 illustrates another alternate interconnection embodiment, where the wirebond 44 connecting the ground plane 40 and the sensor die 30 passes through a hole 42 formed in the conductor assembly 46.

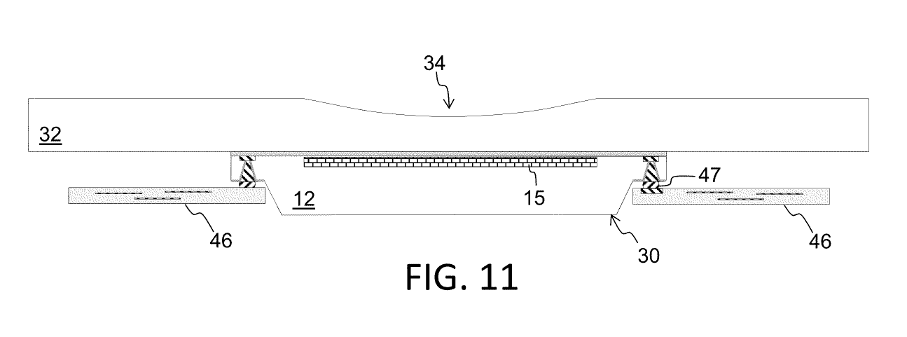

FIG. 11 illustrates another alternate interconnection embodiment, where instead of the ground plane and wirebond, the conductor assembly 46 (e.g. flexible PCB) bonds directly to the sensor die 30 by electrical interconnects 47. Specifically, multiple conductor assemblies 46 could be bonded individually on the sides of the sensor die 30, or a single conductor assembly 46 with a window or aperture in which the sensor die 30 is at least partially disposed could be bonded to the sensor die 30. Interconnects 47 between the conductor assembly 46 and the sensor die 30 can be conductive bumping or any other flip chip configuration. A ground plane can be routed through the conductor assembly 46 to another structure of the device if needed.

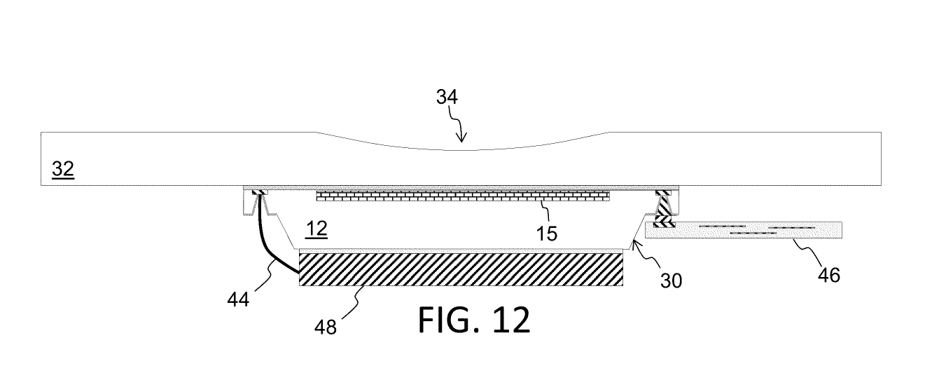

FIG. 12 illustrates yet another alternate interconnection embodiment, where a conductive ground plane 48 is attached to the back surface of the sensor die 30. Wirebond 44 is used to connect the ground plane 48 to the sensor die 30, and conductor assembly 46 is used to connect the sensor die 30 to external circuits.

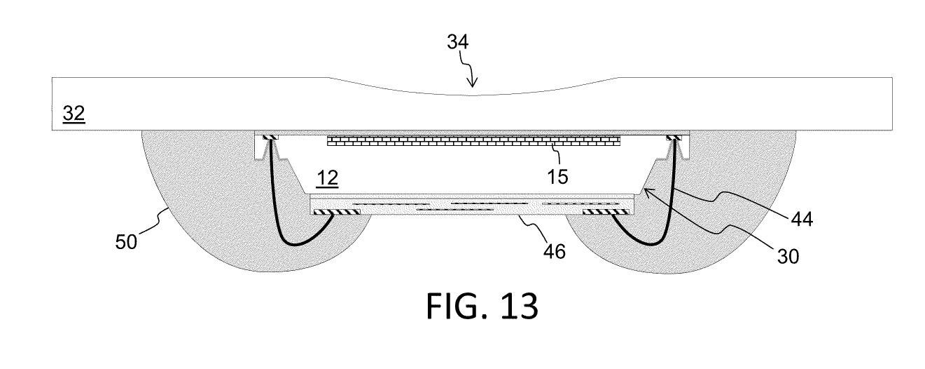

FIG. 13 illustrates yet one more alternate interconnection embodiment, where conductor assembly 46 is attached to the back surface of the sensor die 30. Wirebonds 44 are used to connect the sensor die 30 to the conductor assembly 46. An optional encapsulation material 50 can be used to cover and protect wirebonds 44 and their connection points.

It is to be understood that the present invention is not limited to the embodiment(s) described above and illustrated herein, but encompasses any and all variations falling within the scope of the appended claims. For example, references to the present invention herein are not intended to limit the scope of any claim or claim term, but instead merely make reference to one or more features that may be covered by one or more of the claims. Materials, processes and numerical examples described above are exemplary only, and should not be deemed to limit the claims. Further, as is apparent from the claims and specification, not all method steps need be performed in the exact order illustrated or claimed, but rather in any order that allows the proper formation of the packaged sensor of the present invention. Lastly, single layers of material could be formed as multiple layers of such or similar materials, and vice versa.

It should be noted that, as used herein, the terms “over” and “on” both inclusively include “directly on” (no intermediate materials, elements or space disposed therebetween) and “indirectly on” (intermediate materials, elements or space disposed therebetween). Likewise, the term “adjacent” includes “directly adjacent” (no intermediate materials, elements or space disposed therebetween) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements therebetween, as well as forming the element indirectly on the substrate with one or more intermediate materials/elements therebetween.

What is claimed is:

1. A sensor device comprising:
a sensor die comprising:
a first substrate having front and back surfaces,
a sensor disposed in or at the front surface,
bond pads disposed in or at the front surface and electrically coupled to the sensor, and
a plurality of openings each extending from the back surface to one of the bond pads;
a second substrate having top and bottom surfaces, wherein the bottom surface of the second substrate is mounted to the front surface of the first substrate; and
a conductor assembly electrically coupled to at least some of the bond pads through at least some of the openings.

2. The sensor device of claim 1, wherein the first substrate includes a recess formed into the front surface and disposed over the sensor.

3. The sensor device of claim 1, wherein each of the openings comprises a trench formed into the back surface, and a hole extending from the trench to one of the bond pads.

4. The sensor device of claim 1, wherein the conductor assembly is a flexible printed circuit board.

5. The sensor device of claim 1, further comprising:
conductive material disposed on and/or in the second substrate to form a ground plane;
a wirebond extending through one of the openings and electrically connecting the conductive material to one of the bond pads.

6. The sensor device of claim 5, wherein the wirebond is electrically coupled to the conductor assembly, and the conductor assembly is electrically coupled to the conductive material.

7. The sensor device of claim 5, wherein the wirebond extends through a hole in the conductor assembly.

8. The sensor device of claim 5, wherein the second substrate includes one or more slots formed therein, and wherein the conductive material is at least partially disposed in the one or more slots.

9. The sensor device of claim 1, wherein the conductor assembly is mounted to the bottom surface of the second substrate, and wherein the conductor assembly is electrically coupled to at least some of the bond pads through at least some of the openings by wirebondings.

10. The sensor device of claim 1, wherein the conductor assembly is mounted to the sensor die by electrical interconnects each of which extend between one of the bond pads and the conductor assembly.

11. The sensor device of claim 1, further comprising:
conductive material mounted to the back surface of the first substrate;
a wirebond extending through one of the openings and electrically connecting the conductive material to one of the bond pads.

12. The sensor device of claim 1, wherein the conductor assembly is mounted to the back surface of the first substrate, and wherein the conductor assembly is electrically coupled to at least some of the bond pads through at least some of the openings by wirebondings.

13. The sensor device of claim 12, further comprising:
encapsulation material surrounding the wirebondings.

14. A method of forming a sensor device comprising:
providing a sensor die that comprises:
a first substrate having front and back surfaces,
a sensor disposed in or at the front surface, and
bond pads disposed in or at the front surface and electrically coupled to the sensor;
forming a plurality of openings each extending from the back surface to one of the bond pads;
mounting a bottom surface of a second substrate to the front surface of the first substrate; and
electrically coupling a conductor assembly to at least some of the bond pads through at least some of the openings.

15. The method of claim 14, further comprising:
forming a recess into the front surface of the first substrate such that the recess is disposed over the sensor.

16. The method of claim 14, wherein the forming of at least one of the openings comprises:
forming a trench into the back surface, and
forming a hole extending from the trench to one of the bond pads.

17. The method of claim 14, further comprising:
forming a ground plane of conductive material on and/or in the second substrate; and
electrically coupling a first end of a wirebond to the conductive material and a second end of the wirebond to one of the bond pads.

18. The method of claim 17, wherein the forming of the ground plane comprises:
forming one or more slots in the second substrate, and
positioning the conductive material at least partially in the one or more slots.

19. The method of claim 14, further comprising:
mounting the conductor assembly to the bottom surface of the second substrate, and
electrically coupling the conductor assembly to at least some of the bond pads with wirebondings.

20. The method of claim 14, further comprising:
mounting the conductor assembly to the sensor die using electrical interconnects each of which extend between one of the bond pads and the conductor assembly.

21. The method of claim 14, further comprising:
mounting conductive material to the back surface of the first substrate;
electrically coupling a first end of a wirebond to the conductive material and a second end of the wirebond to one of the bond pads.

22. The method of claim 14, further comprising:
mounting the conductor assembly to the back surface of the first substrate, wherein the electrical coupling includes electrically coupling first ends of wirebonds to the conductor assembly and second ends of the wirebonds to at least some of the bond pads.
